(19) United States
(12) Patent Application Publication
(10) Pub. No.: US 2009/0244664 A1
(43) Pub. Date: Oct. 1, 2009

(54) Image Processing Device, Image Processing Method, and Program

(75) Inventor: Masashi KANAI, Azumino-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/411,726

(22) Filed: Mar. 26, 2009

(30) Foreign Application Priority Data
Mar. 26, 2008 (JP) 2008-079961

(51) Int. Cl. H04N 1/46

(52) U.S. Cl. 358/530

(57) ABSTRACT

An image processing device converts received color image data in accordance with a color gamut that an image output apparatus can express. A representative color is determined for each of a plurality of pixel aggregates formed by classifying pixels included in the color image data. An initial distribution of representative colors in a predetermined color space is set. An evaluation function takes a value increasing as a chroma difference between representative colors recedes from chroma that in the initial distribution. Apparatus color gamut data represents the color gamut that can be expressed by the image output apparatus chroma. After changing the chroma of a specific representative color in accordance with the color gamut of the image output apparatus, the chroma of the remaining representative colors is changed so that a summation of values of the evaluation function calculated between the representative colors becomes equal to or smaller than a predetermined value. The color image data with respect to each of the pixels is converted in accordance with the changes in the chroma of the representative colors chroma.

### CROSS-REFERENCE TO RELATED APPLICATIONS

This application claims the benefit of priority under 35 USC 119 of Japanese application no. 2008-079961, filed on Mar. 26, 2008, which is incorporated herein by reference.

### BACKGROUND

1. Technical Field

The present invention relates to a technology of outputting (e.g., displaying and printing) a color image based on image data.

2. Related Art

Humans can recognize a wide range of colors from colors with low chroma (e.g., tint colors and dull colors) to colors with high chroma (e.g., bright colors). In contrast, color image data is limited in its color range (color gamut). Depending on hues, the range in chroma that color image data can deal with is significantly limited relative to the sensible range of humans.

In image output apparatuses that output color images, such as color monitors or printers, there is also a limit in the range of color (color gamut) the devices can reproduce. Moreover, since the color gamut that image output apparatuses can reproduce and the color gamut that color image data can deal with are different from each other, it is possible that the image output apparatus does not reproduce colors that the color image data can deal with.

A technology has been proposed of comparing the color gamut of input image data with that of an image output apparatus, compressing the color gamut of the image in hues where the color gamut of the image data is wide, and expanding the color gamut of the image in hues where the color gamut of the image data is narrow, thereby using the color gamut of the image output apparatus as wide as possible while absorbing the difference in the color gamut between the two parties, thus aiming to output a preferable color image (Japanese Patent No. 4016234).

However, this technology has a problem in that a preferable color image may not necessarily be output. This is because even in the case in which the input image is a kind of image using only a low chroma range in a certain hue, the chroma is expanded in accordance with the color gamut of the image output apparatus, and therefore, the chroma in that hue is sometimes expanded excessively. Moreover, as a result of such excessive expansion, in the case in which a certain hue is expressed as a brighter color than another hue, this relation may be reversed in the output image in some cases. Further, even in the case in which such a situation does not occur, as a result that the high chroma range is used in all of the hues in a similar manner, the image is apt to become dull, and therefore, there is a problem that a preferable color image is not necessarily obtained.

### SUMMARY

The invention provides a technology that absorbs the difference in color gamut between images expressed by color image data and an image output apparatus to properly output a color image.

According to one aspect of the invention, an image processing device performs, in response to receiving color image data, a process of converting the color image data in accordance with a color gamut that an image output apparatus can express. A representative color determining unit determines, for each of a plurality of pixel aggregates formed by classifying pixels included in the color image data, a representative color representing the pixel aggregate. An initial distribution setting unit sets a distribution of representative colors in a predetermined color space as an initial distribution. An evaluation function storage unit stores a predetermined evaluation function that takes a value increasing as a chroma difference between one of the representative colors and another of the representative colors recedes from the chroma difference in a condition of the initial distribution. An apparatus color gamut data obtaining unit obtains apparatus color gamut data representing the color gamut that can be expressed by the image output apparatus. A chroma changing unit changes, after changing the chroma of a specific representative color out of the representative colors in accordance with the color gamut of the image output apparatus, the chroma of the remaining representative colors so that a summation of values of the evaluation function calculated between the representative colors becomes equal to or smaller than a predetermined value. An image data converting unit converts the color image data with respect to each of the pixels in accordance with the representative colors changed by the chroma changing unit.

An image processing method according to another aspect of the invention performs, in response to receiving color image data, a process of converting the color image data in accordance with a color gamut that an image output apparatus can express. The image processing method includes the steps of determining, for each of a plurality of pixel aggregates formed by classifying pixels included in the color image data, a representative color representing the pixel aggregate; setting a distribution of the representative colors in a predetermined color space as an initial distribution; storing a predetermined evaluation function that takes a value increasing as a chroma difference between one of the representative colors and another of the representative colors recedes from the chroma difference in a condition of the initial distribution; obtaining apparatus color gamut data representing the color gamut the image output apparatus can express; changing, after changing the chroma of a specific representative color out of the representative colors in accordance with the color gamut of the image output apparatus, the chroma of the remaining representative colors so that a summation of values of the evaluation function calculated between the representative colors becomes equal to or smaller than a predetermined value; and converting the color image data with respect to each of the pixels in accordance with the representative colors changed.

In the image processing device and method according to these aspects of the invention, upon reception of the color image data, the representative color is determined for each of the pixel aggregates, and the chroma of the specific representative color out of these representative colors is changed in accordance with the color gamut of the image output apparatus. Further, the values of the evaluation function between the respective representative colors are obtained, and the chroma of each of the representative colors except the specific representative color is changed so that the summation of the values of the evaluation function becomes equal to or smaller than a predetermined value. An evaluation function is used having a value so that the more significantly the chroma difference between the representative colors varies from the initial condition, the larger the value of the evaluation function becomes. Therefore, when the specific representative color is changed in accordance with the color gamut of the image output apparatus, the chroma of the other representative colors can be changed while preventing the chroma difference between the representative colors from varying significantly from the initial condition. The color image data of each of the pixels in the pixel aggregate is converted along the representative colors thus changed.

According to the process described above, each of the representative colors can be converted in accordance with the color gamut of the image output apparatus taking the positional relationship of the chroma between the representative colors into consideration. Further, by performing the conversion along the representative colors thus converted, the color image data of each of the pixels can be converted in accordance with the color gamut of the image output apparatus. Further, since between the representative colors, the conversion is performed so that the original chroma difference is maintained as much as possible taking the positional relationship of the chroma of the respective representative colors into consideration, the problem that the chroma of the certain hue is extremely expanded, the reversal of the chroma occurs, or all of the hues are similarly expanded to the high chroma range can be prevented from occurring. In addition, since a number of pixels constituting the image is collected into the pixel aggregates to determine the representative color for each of the pixel aggregates, the number of representative colors can be set to be a relatively small number. Therefore, the representative colors can be quickly converted in accordance with the color gamut of the image output apparatus, and as a result, the color image data of each of the pixels can also be quickly converted.

In one embodiment of the image processing device, the representative colors are determined for each of the pixel aggregates as described below. The image expressed by the color image data is divided to form a plurality of areas, and the pixels included in each of the areas are collected as the pixel aggregate. Then, the representative color for each of the pixel aggregates can be determined.

Since such pixel aggregates can easily be formed, the representative colors can quickly be determined. Further, by setting the sizes of the areas to be the same, the number of pixels included in each of the area can also be made constant. As a result, in the case in which a color used at a high frequency exists, a number of representative colors similar to that color should occur, the frequency of use of the color can be reflected to the number of representative colors. Further, by performing the conversion taking the number of representative colors into consideration when converting the representative colors in accordance with the color gamut of the image output apparatus, the frequency of use of the color in the image can be reflected, and eventually, the color image data can be converted while reflecting the frequency of use of the color.

Further, in another embodiment of the image processing device, the representative colors are determined for each of the pixel aggregates as described below. The color image data is converted into a coordinate value in the color space, and the pixels are collected into a plurality of pixel aggregates based on the positional relationship in the color space. The representative color for each of the pixel aggregates thus formed can then be determined.

According to this process, the representative colors are appropriately determined in accordance with the colors used in the image. Further, the representative colors are changed in accordance with the color gamut of the image output apparatus, and the conversion along the representative colors is performed after the change, thereby making it possible to appropriately convert the color image data.

In another embodiment of the image processing device, the evaluation function performs the evaluation so that the more significantly the hue is different between the representative colors, the lighter weight the evaluation is performed with.

According to this process, the chroma of each of the representative colors can be changed in accordance with the color gamut of the image output apparatus in the condition in which the influence for keeping the chroma difference is strong between representative colors with similar hues, while the influence for keeping the chroma difference is weak between representative colors with hues distant from each other. According to experience, even when the chroma difference has significantly varied when the color image data is converted, an uncomfortable feeling provided to the observer is not so strong provided that the hues are different in comparison with the case of having the similar hues. Therefore, by performing the evaluation so that the more significantly the hue is different between the representative colors, the lighter weight the evaluation is performed with, the chroma of each of the representative colors can be appropriately changed in accordance with the difference in the hue.

Similarly, in another embodiment of the image processing device, the evaluation function performs the evaluation so that the more significantly the brightness is different between the representative colors, the lighter weight the evaluation is performed with.

According to this process, the chroma of each of the representative colors can be changed in accordance with the color gamut of the image output apparatus in the condition in which the influence for keeping the chroma difference is strong between the representative colors with similar brightness, while the influence for keeping the chroma difference is weak between the representative colors with brightness significantly different from each other. According to experience, even when the chroma difference has significantly varied when the color image data is converted, an uncomfortable feeling provided to the observer is not so strong provided that the brightness is significantly different in comparison with the case of having the similar brightness. Therefore, by performing the evaluation so that the more significantly the brightness is different between the representative colors, the lighter weight the evaluation is performed with, the chroma of each of the representative colors can be appropriately changed in accordance with the difference in the brightness.

Further, in another embodiment of the image processing device, the evaluation function performs the evaluation so that the larger the number of pixels included in the pixel aggregate is, the heavier weight the representative color is evaluated with.

According to this configuration, since the color used at a higher frequency in the image is evaluated with a heavier weight than a color used at a lower frequency, the color image data can be converted so that a color with high frequency of use is output appropriately.

In another embodiment of the image processing device, the representative color is determined in the following manner. First, color gamut data representing the range of color expressed by pixels in the pixel aggregate is attached to the color image data. Then, when receiving such color image data, the color gamut data attached thereto is read out. The representative colors are thus determined based on the color gamut data of each of the pixel aggregates.

According to this configuration, by previously attaching the color gamut data to the color image data, the representative colors of the pixel aggregates can be quickly determined regardless of the type of pixel aggregate, and eventually, the color image data can be quickly converted in accordance with the color gamut of the image output apparatus.

The image processing method of the invention described above can also be realized using a function of a computer in the form of a computer program embodied in a computer-readable medium. Specifically, a program embodied in a computer-readable medium makes a computer realize a process of converting, in response to receiving color image data, the color image data in accordance with a color gamut that an image output apparatus can express. The process includes determining, for each of a plurality of pixel aggregates formed by classifying pixels included in the color image data, a representative color representing the pixel aggregate; setting a distribution of representative colors in a predetermined color space as an initial distribution; storing a predetermined evaluation function that takes a value increasing as a chroma difference between one of the representative colors and another of the representative colors recedes from the chroma difference in a condition of the initial distribution; obtaining apparatus color gamut data representing the color gamut the image output apparatus can express; changing, after changing the chroma of a specific representative color out of the representative colors in accordance with the color gamut of the image output apparatus, the chroma of the remaining representative colors so that a summation of values of the evaluation function calculated between the representative colors becomes equal to or smaller than a predetermined value; and converting the color image data with respect to each of the pixels in accordance with the representative colors changed.

By reading such a program in a computer, and making the computer realize the functions corresponding to the steps of the process, the color gamut of the image expressed by the color image data is appropriately converted in accordance with the color gamut of the image output apparatus, and a preferable color image is output.

### BRIEF DESCRIPTION OF THE DRAWINGS

The invention will now be described with reference to the accompanying drawings, wherein like numbers reference like elements.

FIG. 1 is an explanatory diagram showing an overall configuration of a system to which an image processing device of an embodiment of the present invention is applied.

FIG. 2 is a flowchart of a color gamut mapping process according to the invention for converting color image data in accordance with the color gamut of an image output apparatus.

FIG. 3 is a flowchart of a process for extracting a representative color in the color mapping process of FIG. 2.

FIG. 4 is an explanatory diagram showing a process of generating pixel aggregates by dividing an image into a plurality of areas.

FIG. 5 is an explanatory diagram showing various methods for determining the representative color of the pixel aggregate.

FIG. 6 is an explanatory diagram exemplifying the color gamut of an image output apparatus.

FIG. 7 is a flowchart of a representative color conversion process for converting a representative color that is obtained for each of the pixel aggregates, in accordance with the color gamut of the image output apparatus.

FIGS. 8A and 8B are explanatory diagrams showing a process of normalizing the representative color, which is obtained for each of the pixel aggregates, in accordance with the color gamut of the image output apparatus.

FIGS. 9A-9C are explanatory diagrams showing a process of changing the chroma of a specific representative color in accordance with the color gamut of the image output apparatus, and then changing the chroma of the other representative colors.

FIGS. 10A-10C are explanatory diagrams exemplifying the simplest evaluation function.

FIGS. 11A-11C are explanatory diagrams exemplifying the evaluation function used in the invention.

FIG. 12 is a flowchart of a process of converting the image data of each of the pixels in the pixel aggregate.

FIG. 13 is an explanatory diagram showing a process of converting image data of a conversion pixel based on the normalized chroma of a converted representative color.

FIG. 14 is an explanatory diagram showing a process of calculating the chroma for converting color image data of a conversion pixel in a first modified example.

FIG. 15 is an explanatory diagram showing a process of generating a pixel aggregate with a cluster of colors expressed by image data of the pixels in a second modified example.

FIG. 16 is an explanatory diagram showing a condition of data expressing the color gamut stored for each of the pixel aggregates.

FIG. 17 is an explanatory diagram exemplifying a calculating formula for calculating an evaluation function in consideration of the number of pixels included in a pixel aggregate.

### DESCRIPTION OF EXEMPLARY EMBODIMENTS OF THE INVENTION

Embodiments of the invention are explained herein in the following order in order to clarify the contents of the invention described above.
A. Overall Configuration
B. Color Gamut Mapping Process
C. Modified Examples
   C-1. First Modified Example
   C-2. Second Modified Example

### A. Overall Configuration

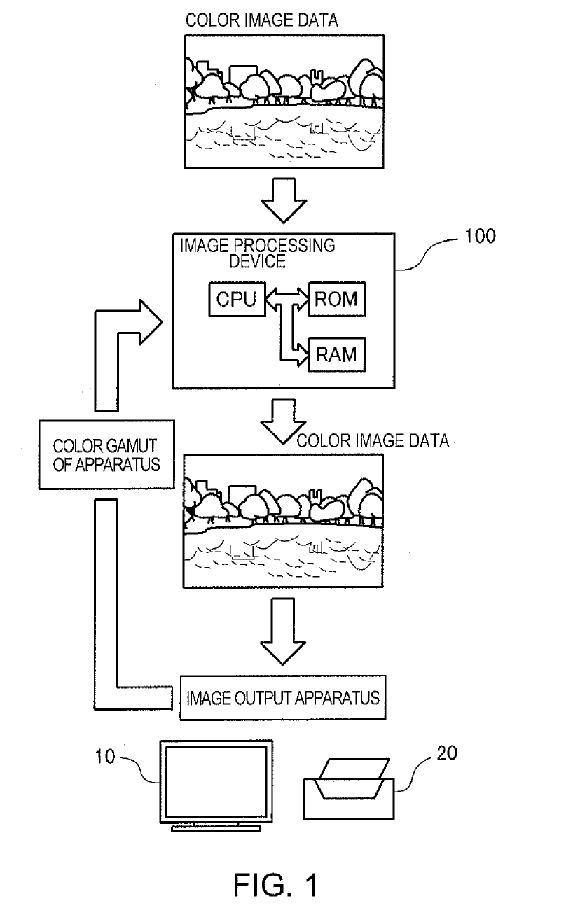

FIG. 1 is an explanatory diagram showing an overall configuration of a system to which an image processing device 100 of an embodiment of the present invention is applied. The image processing device 100 is provided with a CPU, a ROM, a RAM, and so on that communicate data with each other via a bus. When receiving color image data expressing a color image, the image processing device 100 supplies a device (e.g., a color monitor 10 and a color printer 20) that outputs an image with the color image data. The color monitor 10 and the color printer 20 have different ranges (color gamuts) of reproducible colors, and these color gamuts may also be different from a color gamut of colors the color image data can express. Therefore, some colors expressed by the color image data may not be reproducible with an image output apparatus such as the color monitor 10 or printer 20.

Therefore, the image processing device 100 obtains data that represents the color gamut reproducible with the image output apparatus, from the image output apparatus, and converts the color image data in accordance with the color gamut of the apparatus. By supplying the image output apparatus such as the color monitor 10 or printer 20 with color image data thus obtained, a color image is output. Here, when converting the color image data in accordance with the color gamut of the apparatus, the pixels constituting the color image are first classified into a plurality of pixel aggregates. Then, the representative color representing each of the pixel aggregates is obtained, and the chroma of each of the representative colors is converted in accordance with the color gamut of the apparatus. The chroma of the representative color is converted taking into account not only the relationship between the color gamut of the apparatus and each of the representative colors, but also the relationship between the representative colors. Since the colors of all of the pixels constituting the image are not taken as the target, and instead the representative colors of the pixel aggregates obtained by grouping the pixels into a plurality of pixel aggregates are taken as the target, even in the case of considering the relationship between the representative colors in addition to the color gamut of the apparatus, it is possible to quickly convert the chroma of the representative colors in accordance with the color gamut of the apparatus. After converting the chroma of the representative colors of the respective pixel aggregates in this manner, the color image data is converted so that the chroma is changed in the same manner with respect also to the pixels included in the pixel aggregates.

In the image processing device 100, as a result of the conversion of the color image data described above, it is possible to constantly output preferable color images while absorbing the difference between the color gamut of the image expressed by the color image data and the color gamut of the image output apparatus. A process of the image processing device 100 for converting the color image data is now explained.

### B. Color Gamut Mapping Process

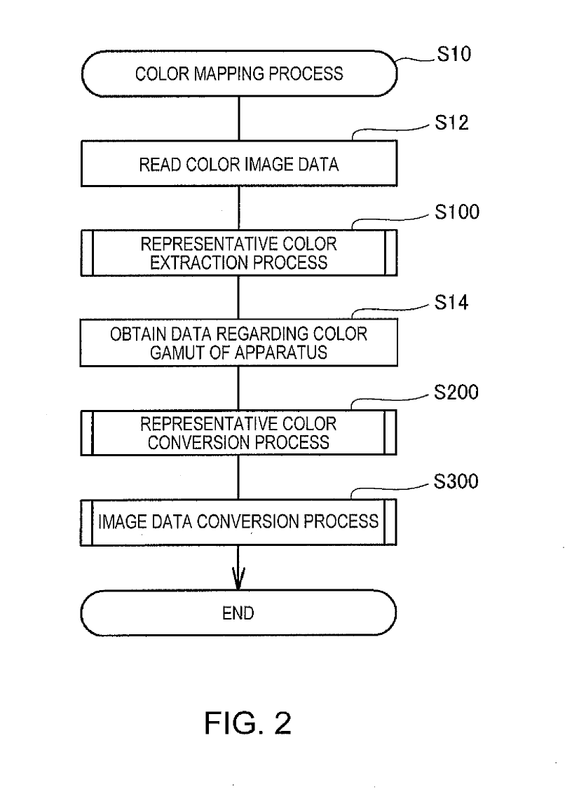

FIG. 2 is a flowchart of a color gamut mapping process of the image processing device 100 for converting color image data in accordance with the color gamut of the image output apparatus. In the color gamut mapping process (step S10), a process of reading the color image data of the image to be output is first executed (step S12). While various types of color image data can be used, the explanation here assumes that the color image data is RGB image data, namely, image data describing grayscale values of R, G and B components for each of the pixels.

When the color image data is read, a process of extracting the representative colors is commenced (step S100). Here, the representative color is as follows. First, the color image data expresses an image using three primary components (R, G and B) of the color of each of the pixels obtained by dividing the image into a plurality of small pixels. In the color mapping process of the present invention, the images are not treated as they are. Rather, the pixels are classified to generate a plurality of pixel aggregates, and the images are treated as collectives of these pixel aggregates. The color representing the pixel aggregate is the representative color.

When classifying the pixels, various classification methods can be applied. For example, in the simplest way, the image is divided into a plurality of areas and the pixels constituting each of the areas are collected as the pixel aggregate. Alternatively, if the image is composed of a plurality of layers, each of the layers may be used as the pixel aggregate. Moreover, it is also possible to analyze the image to extract objects, and to collect the pixels constituting each of the objects as the pixel aggregate. In the following description, for sake of convenience of understanding, the simplest case in which the image is divided into a plurality of areas to be used as the pixel aggregates is explained.

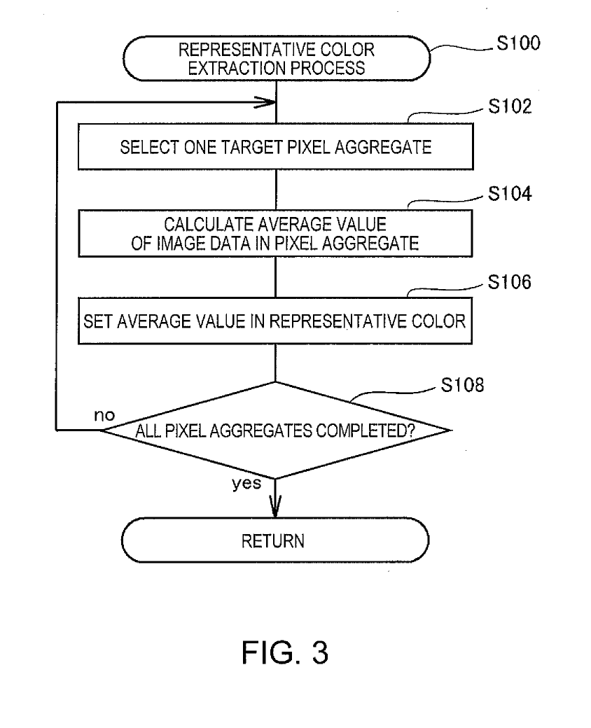

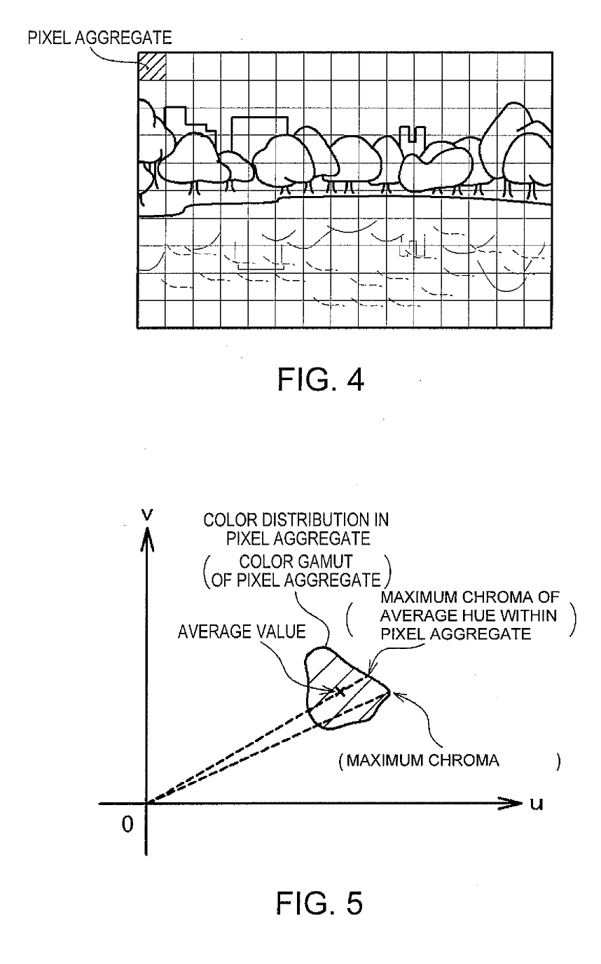

FIG. 3 is a flowchart of the process for extracting the representative color in the color mapping process of FIG. 2. When the representative color extraction process (step S100) is commenced, one of the pixel aggregates is selected to be the object (step S102). FIG. 4 shows a condition in which the pixel aggregates are formed by dividing the image into a plurality of areas. In the step S102, one of these areas is selected as the target pixel aggregate from which the representative color is extracted.

An average value of the image data in the selected pixel aggregate is then calculated (step S104). Specifically, the image data of each of the pixels included in the pixel aggregate are averaged for each of the components, thereby calculating the image data representing the pixel aggregate. After calculating the average value of the image data of the pixel aggregate, the average value is set as the representative color of the pixel aggregate (step S106).

Although the explanations herein assume that the average value of the image data in the pixel aggregate is used as the representative color, values besides the average value can be used as the representative color. For example, the image data with the highest chroma in the pixel aggregate can be used as the representative color. Alternatively, a color distribution (i.e., color gamut of the pixel aggregate) expressed by the pixels in the pixel aggregate is detected. Then, an average hue (the hue of the average value of the image data) in the pixel aggregate is obtained, and the image data with the maximum chroma in the average hue can be used as the representative color.

Further, the color gamut of the pixel aggregate can be arranged to extract the representative color of the pixel aggregate by reading out the color gamut previously added to the color image data as the color gamut data for each of the pixel aggregates instead of extraction by the image processing device 100 analyzing the image data. Further, in the case of determining the representative color using the color gamut data added thereto, the image data expressing the color at the center of the color gamut can be used as the representative color, or the image data with the maximum chroma in the hue at the center of the color gamut can be used as the representative color. FIG. 5 shows various methods for determining the representative color of the pixel aggregate.

After determining the representative color for one of the pixel aggregates in a manner as described above (step S106), whether or not the representative colors are determined in all of the pixel aggregates of the image is determined (step S108). When there is a pixel aggregate whose representative color has not been determined yet (NO in the step S108), the process returns to step S102 to select a new pixel aggregate, and the subsequent series of processes are executed on the newly selected pixel aggregate. When the representative colors are determined in all of the pixel aggregates (YES in the step S108), the representative color extraction process of FIG. 3 is terminated, and the process returns to the color mapping process of FIG. 2.

After extracting the representative color of each of the pixel aggregates (step S100), data regarding the color gamut of the image output apparatus expected to output the color image is obtained (step S14).

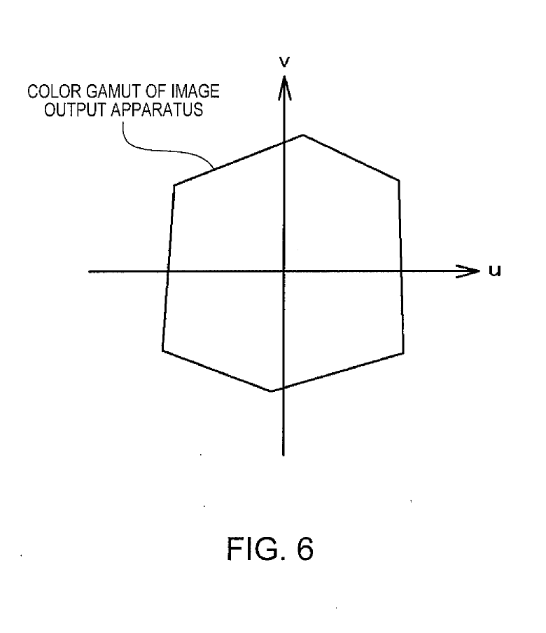

FIG. 6 is an explanatory diagram exemplifying a color gamut of an image output apparatus. The color gamut of the apparatus can be expressed as a series of the outermost points of the colors that can be displayed in an arbitrary color space (assumed here to be an Luv color space). More simply, it can be expressed by connecting the outermost points in typical hues obtained previously. Such color gamut data should be obtained in advance for each image output apparatus. In step S14 of FIG. 2, a process of communicating with the image output apparatus to obtain previously stored color gamut data is executed. The color gamut data of each device can also be stored inside the image processing device 100, and read out in accordance with the image output apparatus.

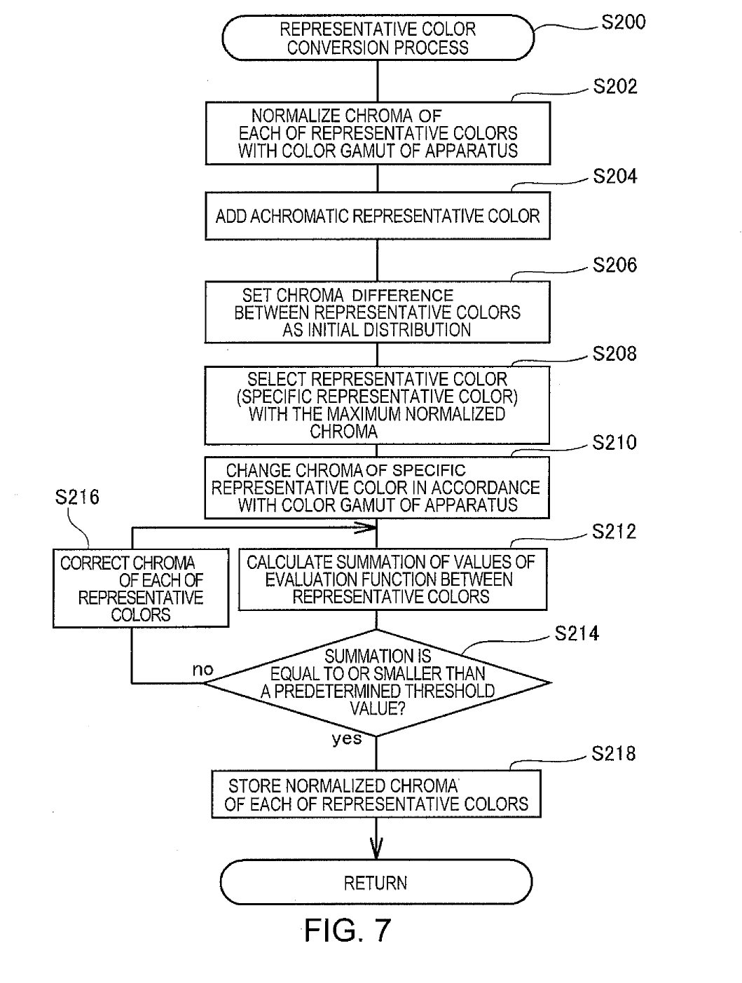

After obtaining the representative color of each of the pixel aggregates and the color gamut of the apparatus, a process of converting the representative colors in accordance with the color gamut of the apparatus is then executed (step S200). FIG. 7 is a flowchart of a representative color conversion process for converting a representative color that is obtained for each of the pixel aggregates, in accordance with the color gamut of the image output apparatus. In the representative color conversion process, the representative colors are first normalized in accordance with the color gamut of the image output apparatus (step S202).

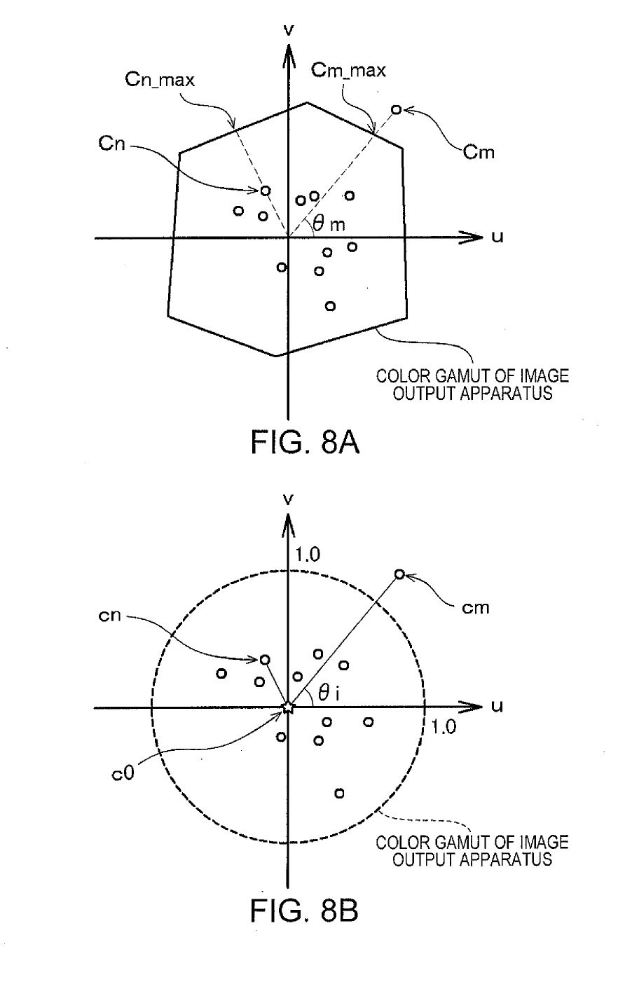

FIGS. 8A and 8B are explanatory diagrams showing the process of normalizing a representative color that is obtained for each of the pixel aggregates, in accordance with the color gamut of the image output apparatus. FIG. 8A shows the condition before executing normalization, namely, the positional relationship between the color gamut of the image output apparatus and each of the representative colors. In FIG. 8A, the representative colors are indicated with white circles, and the color gamut of the image output apparatus is indicated with a solid polygon. Normalization is executed as follows. Focusing attention on a certain representative color, the chroma Cm of the representative color corresponds to the distance (the distance from the origin represented on the uv plane) from the L-axis in the Luv color space. The hue of the representative color corresponds to the angle θm with the u-axis represented on the uv plane. Therefore, by obtaining the maximum chroma Cm_max the image output apparatus can express in the same hue θm, and then dividing the chroma Cm of the representative color by the maximum chroma Cm_max of the device, the normalized chroma cm is obtained. FIG. 8B shows the result of such an operation executed on all of the representative colors. After normalization, the color gamut of the image output apparatus is expressed by a circle with a radius of 1.0, and the representative colors are expressed as relative values with respect to the color gamut of the image output apparatus. The unnormalized chroma is hereinafter denoted with a capital C while the normalized chroma is denoted with a lowercase letter c.

An achromatic representative color is added to the normalized representative color thus obtained (step S204). In FIG. 8B, an added achromatic representative color c0 is indicated with a star mark. After calculating the chroma differences between the representative colors including the added representative color, those chroma differences are stored as an initial distribution (step S206). The chroma difference is calculated for every combination of two of the normalized representative colors, and the chroma differences are stored.

The representative color (specific representative color) having the maximum normalized chroma is then selected (step S208). Generally, the representative color with the maximum chroma is often unique, but when by chance there are two or more representative colors with the maximum chroma, it is possible to select one of them as the specific representative color, or to select all of them as the specific representative colors. In the example shown in FIG. 8B, the representative color with the chroma cm is selected as the specific representative color.

After selecting the specific representative color, the chroma of the specific representative color is changed in accordance with the color gamut of the image output apparatus (step S210). As described above, since the chroma of each of the representative colors has previously been normalized in accordance with the chroma of the image output apparatus, it is enough only to change the chroma of the specific representative color to a constant value (e.g., 0.9) smaller than 1.0.

The reason that it is changed to a value smaller than 1.0 instead of being changed to 1.0 is as follows. As described with reference to FIG. 3, the average value of the image data in the pixel aggregate is taken as the representative color of the pixel aggregate. Therefore, a pixel with image data having higher chroma than that of the representative color may exist in the pixel aggregate. Thus, if the chroma of the specific representative color is changed to 1.0, some pixels in the pixel aggregate corresponding to the specific representative color may run off the color gamut of the image output apparatus. Accordingly, the chroma of the specific representative color is changed to a value smaller than 1.0 so as to fit such pixels into the color gamut of the image output apparatus. When the color with the maximum chroma in the pixel aggregate is taken as the representative color, as shown in FIG. 5, rather than taking the average value of the image data in the pixel aggregate as the representative color, the chroma of the specific representative color can be changed to 1.0 in step S210 of FIG. 7.

Subsequently, in conjunction with changing the chroma of the specific representative color, a process of changing the chroma of the other representative colors is executed (step S212). When changing the chroma of the other representative colors, the process is executed using the evaluation function set previously. Here, the evaluation function is set to have the following characteristics.

### Characteristic 1

The more significantly the chroma difference between the two representative colors is varied from the initial value, the larger the value becomes. Here, it is assumed that the variation in the chroma difference is treated without discriminating the case in which the chroma difference increases from the case in which the chroma difference decreases.

### Characteristic 2

If the chromatic difference between two representative colors is the same as the initial value, the value becomes 0.

Many functions exist that have these two characteristics and that can be used as the evaluation function. A specific example of an evaluation function is explained herein. For sake of convenience of understanding, assuming that the evaluation function is given in the mean time, a rough outline of the process of changing the chroma of the representative color using the evaluation function is explained.

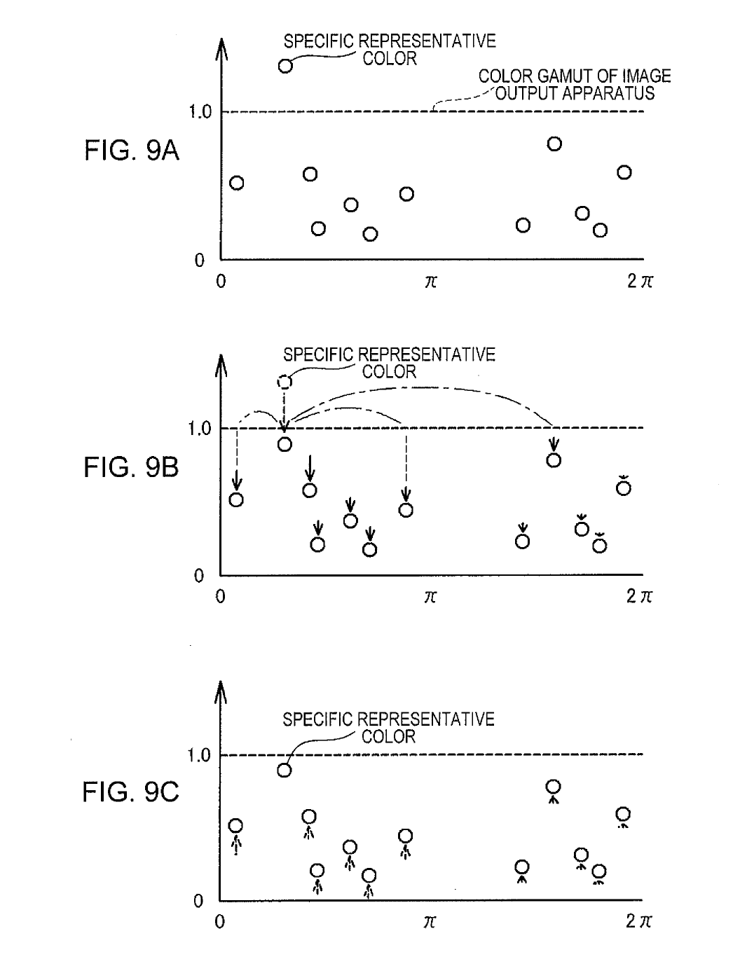

FIGS. 9A-9C are explanatory diagrams showing a process of changing the chroma of the specific representative color in accordance with the color gamut of the image output apparatus, and then changing the chroma of the other representative colors. In FIGS. 9A-9C, the angle corresponding to the hue of the representative color is assigned to the horizontal axis and the normalized chroma of the representative color is assigned to the vertical axis. Since the chroma is normalized, the color gamut of the image output apparatus has the chroma of 1.0.

FIG. 9A represents an initial distribution of the representative colors normalized with respect to the color gamut of the image output apparatus. FIG. 9B represents the condition in which the chroma of the specific representative color is changed in accordance with the color gamut of the image output apparatus. In FIG. 9B, since the chroma of the specific representative color comes closer to the chroma of the other representative colors when the chroma of the specific representative color is changed, the chroma difference between the specific representative color and the other representative color becomes smaller than in the condition of the initial distribution. Therefore, the value of the evaluation function between the specific representative color and the other representative color increases. The chroma of the other representative color is thus changed so that the value of the evaluation function becomes as small as possible in the condition of fixing the specific representative color thus changed and the achromatic representative color. In the condition shown in FIG. 9B, since the value of the evaluation function increases with respect to the other representative colors in accordance with the reduction of the chroma of the specific representative color, the value of the evaluation function can be reduced by reducing the chroma of the other representative colors (except the achromatic representative color). The arrows of FIG. 9B show the process of changing the chroma of the other representative colors in the reducing direction as a result of reducing the chroma of the specific representative color. The force indicated with the arrows acts on the other representative colors by reducing the chroma of the specific representative color.

On the other hand, since it is assumed that the achromatic representative color is not moved, if the chroma of the other representative color is made smaller as shown in FIG. 9B, the chroma difference with respect to the achromatic representative color becomes smaller than in the condition of the initial distribution. Therefore, if a reduction in the chroma of the other representative color is attempted in order to assure the chroma difference with respect to the specific representative color, the force in the direction of holding back this movement is applied with respect to the achromatic representative color. In FIG. 9C, the force that the other representative color receives from the achromatic representative color is represented with the arrows.

Hereinabove, the force acting on the other representative colors based on the evaluation function between the specific representative color and the other representative colors when changing the chroma of the specific representative color (FIG. 9B), and the force acting on the other representative colors based on the evaluation function with respect to the achromatic representative color (FIG. 9C) are explained. The evaluation function can be calculated between the other representative colors, and the force acting thereon so as to reduce the values of the evaluation function can be assumed. Further, if the chroma of each of the representative colors is determined as the chroma with which the summation of the values of the evaluation function between all of the representative colors becomes the minimum, the chroma of each of the representative colors can appropriately be changed in accordance with the color gamut of the image output apparatus.

Hereinabove, the basic concept of changing the chroma of each of the representative colors in accordance with the color gamut of the image output apparatus using the evaluation function is described. In practice, it is desirable to develop this idea to add the weight so that, for example, the more distant the hues of the representative colors become, the smaller the value of the evaluation function becomes. Similarly, it is also desirable to add the weight so that the greater the difference in brightness between the representative colors becomes, the smaller the value of the evaluation function becomes.

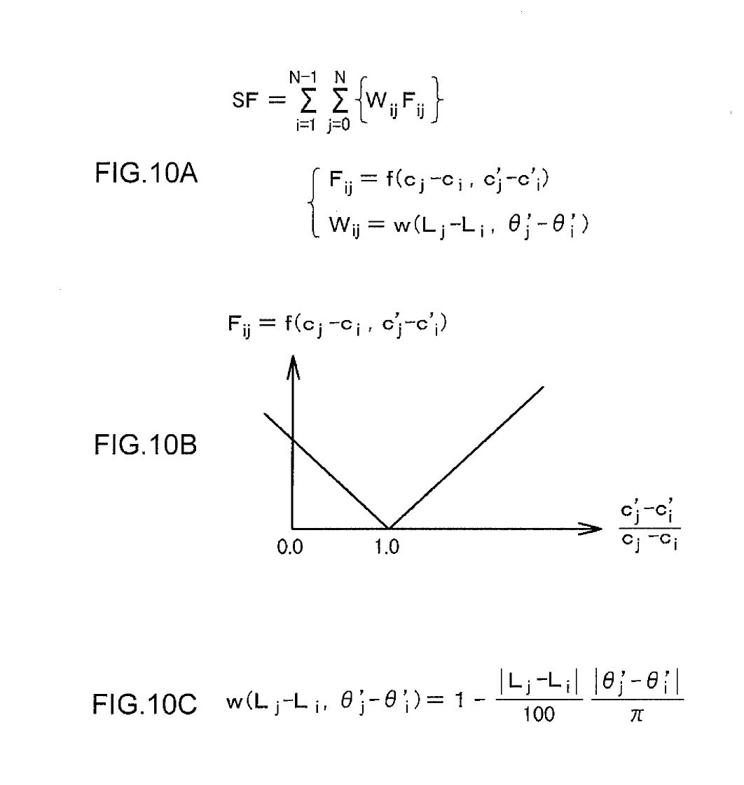

FIGS. 10A-10C are explanatory diagrams showing an example of the evaluation function used in the representative color conversion process. FIG. 10A shows a calculation formula for obtaining the summation SF of the evaluation function values; FIG. 10B shows a specific example of the evaluation function F; and FIG. 10C shows a specific example of the weighting factor W to be multiplied by the evaluation function. The calculation formula shown in FIG. 10A is first explained. Fᵢⱼ shown in FIG. 10A denotes the evaluation function between the ith representative color and the jth representative color. Wij denotes the weighting factor between the ith representative color and the jth representative color. “cᵢ” denotes the normalized chroma with respect to the ith representative color, and “c′ᵢ” denotes the normalized chroma of that representative color after the change is made thereon. “Lᵢ” denotes the brightness of the ith representative color, and “θi” denotes the hue of the ith representative color.

In the calculation formula of FIG. 10A, focusing attention on the ith representative color, the value obtained by multiplying the evaluation function F by the weighting factor W between the ith representative color and all of the representative colors. This operation is executed on all of the representative colors expect the specific representative color and the achromatic representative color, and the summation of the values obtained in this manner is expressed. Because the specific and achromatic representative colors are excepted, in the calculation formula shown in FIG. 10A, the variable j takes the value from 0 to N while the variable i takes the value from 1 to (N−1).

The function shown in FIG. 10B can be used, for example, as the evaluation function F. The function satisfies the two characteristics described above, namely, that the more significantly the chroma difference between the two representative colors is varied from the initial value, the larger the value becomes, and that if the chromatic difference between two representative colors is the same as the initial value, the value becomes 0. Therefore, it can be used as the evaluation function. The function of FIG. 10C can be used, for example, as the weighting factor W. By using such a weighting factor W, the more significantly the brightness is different between the representative colors, the smaller the value of the weighting factor becomes. In particular, when the angular difference between the hues of the representative colors is π, the value of the weighting factor becomes 0. Since the chroma difference is not considered between the representative colors in the relationship of the complementary color, the chroma can be changed without exerting an influence on each other.

As the simplest evaluation function, a function satisfying only Characteristics 1 and 2 can be used. However, from the viewpoint of convenience of the actual process, it is desirable to use a function having the following characteristic 3 in addition to executing the discrimination between the case in which the chroma difference increases and the case in which the chroma difference decreases.

### Characteristic 3

The sign is reversed between the case in which the chroma difference between the two representative colors increases from the initial value and the case in which the chroma difference between the two representative colors decreases from the initial value.

Further, the function obtained by multiplying such a function by itself, or the function of taking the absolute value of such a function can be used as the evaluation function. In the representative color conversion process of FIG. 7, the representative color is converted using such an evaluation function.

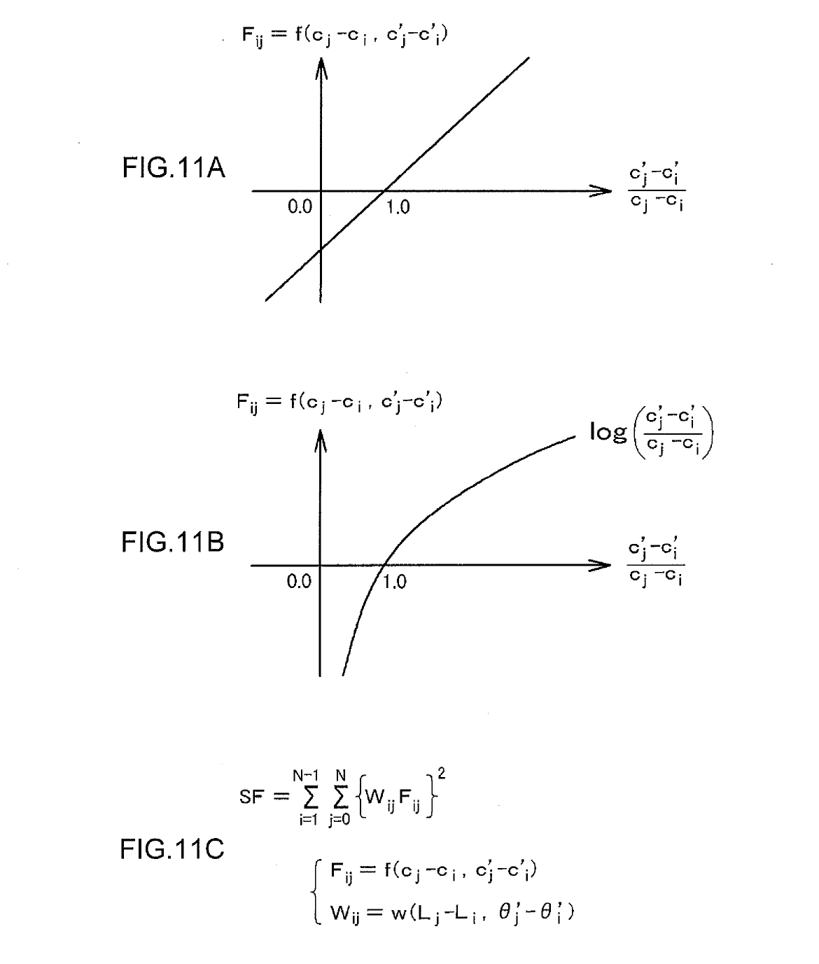

FIGS. 11A-11C are explanatory diagrams exemplifying the evaluation function used in the representative color conversion process of this embodiment. In the example of FIG. 11A or 11B, a function is used having a sign that becomes negative if the chroma difference (c′ⱼ−c′ᵢ) after the change becomes smaller than the chroma difference (cⱼ−cᵢ) in the condition of the initial distribution. The function obtained by multiplying either one of these functions by itself is used as the evaluation function. The absolute value of either one of these functions can also be used as the evaluation function, instead of multiplying by itself.

In step S212 of FIG. 7, the summation of the evaluation function values is calculated along the calculation formula shown in FIG. 11C between the representative colors changed in the chroma after changing the chroma of the specific representative color in accordance with the color gamut of the image output apparatus (step S210). Whether or not the value of the summation thus calculated is smaller than a predetermined threshold value is then determined (step S214). If the value of the summation is larger than the predetermined threshold value (NO in the step S214), the chroma of each of the representative colors is corrected (step S216).

When the function of FIG. 11A or 11B is used by multiplying itself or taking the absolute value as the evaluation function, the chroma of each of the representative colors can be appropriately corrected. Specifically, the function of FIG. 11A or 11B takes a positive value when the chroma difference between the two representative colors becomes greater than the chroma difference in the initial distribution, and takes a negative value when it becomes smaller than the chroma difference in the initial distribution. Therefore, focusing attention to a certain representative color, the summation of the function values with respect to all combinations of that representative color and the rest of the representative colors is calculated. If the summation of the function values is positive, a correction along the direction of reducing the chroma is executed on the representative color, and if the summation of the function values is negative, a correction along the direction of increasing the chroma is executed thereon. The amount of correction can be set as a value proportional to the summation of the function values. In step S216 of FIG. 7, with respect to all of the representative colors except the fixed representative colors (the specific and achromatic representative colors), the process of correcting the chroma is executed along the correction amounts calculated in the manner described above.

In the case of using the function of FIG. 11B, when the chroma difference between the two representative colors approaches 0, the function value suddenly becomes large, and at the chroma difference of 0, the function value becomes divergent to negative infinity. Therefore, if such a function is used, when the relationship of the chroma between the representative colors is on the verge of being reversed from the condition of the initial distribution, an extremely strong force results in the direction of holding back the reversal. Therefore, by using the function of FIG. 11B, the representative color can be changed so as not to cause the reversal of the chroma between the representative colors. In contrast, when the function of FIG. 11A is used, it becomes possible to change the representative colors while, in some cases, allowing the reversal of the chroma between the representative colors.

After correcting the chroma of the representative colors in the manner described above, with respect to the distribution of the corrected representative colors, the summation of the evaluation function values between the representative colors is calculated again (step S212), and it is then determined whether or not the value of the summation thus newly calculated is equal to or smaller than the predetermined threshold value (step S214). If the value of the summation is greater than the threshold value (NO in the step S214), the chroma of each of the representative colors is corrected again (step S216), and the summation of the evaluation function values between the representative colors is then calculated with the newly corrected distribution of the representative colors. By repeating this operation, the summation of the evaluation function values is reduced gradually, and is determined, in due course, to be smaller than the threshold value (YES in the step S214). Therefore, after storing chroma the normalized chroma of each of the representative colors thus obtained (step S218), the representative color conversion process of FIG. 7 is terminated, and the process returns to the color mapping process of FIG. 2.

In the above description, it is assumed that when the summation of the evaluation function values becomes smaller than the threshold value (YES in the step S214 shown in FIG. 7), the repeat calculation is aborted and the chroma of each of the representative colors is stored. However, depending on the distribution condition of the representative colors or the setting of the evaluation function, a case in which the minimum value of the summation is still larger than the threshold value may occur. In such a case, the repeat calculation can be aborted upon detection that the summation becomes the minimum value or upon detection that the variation of the summation becomes equal to or smaller than a predetermined value.

After changing the representative colors obtained for the respective pixel aggregates in accordance with the color gamut of the image output apparatus in the manner described above, a process of converting the image data of each of the pixels in the pixel aggregate is then commenced (step S300 of FIG. 2).

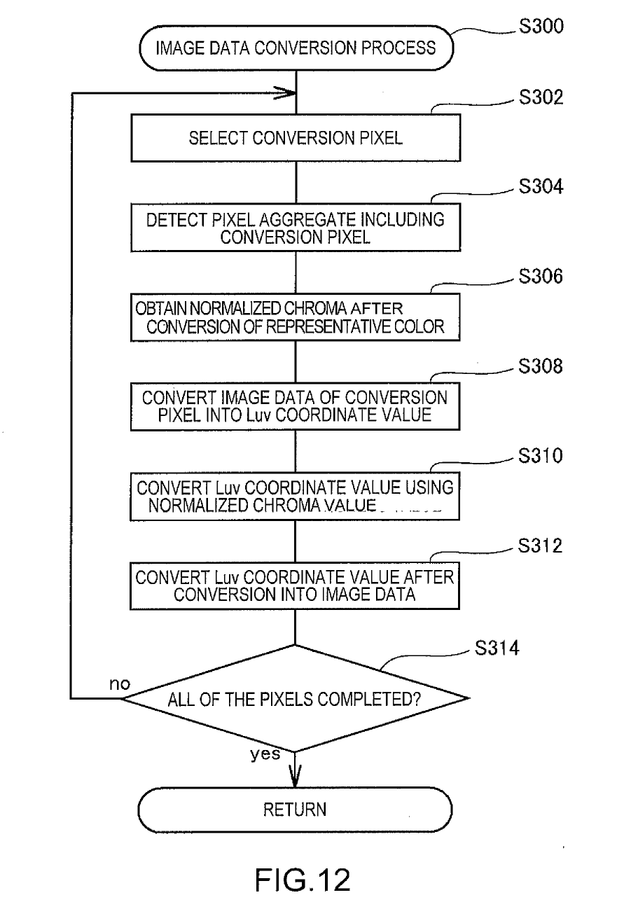

FIG. 12 is a flowchart of the process of converting the image data of each of the pixels in the pixel aggregate. When the image data conversion process (step S300) for converting the image data of each of the pixels is commenced, one of the pixels to be converted (the conversion pixel) is first selected (step S302). The pixel aggregate including the conversion pixel is detected (step S304). Since the image is divided into a plurality of areas to define pixel aggregates as shown in FIG. 4, the area including the conversion pixel is detected in the step S304.

As described above, the representative color is obtained in each of the pixel aggregates (here, the areas), and each of the representative colors is converted in accordance with the color gamut of the image output apparatus, and is stored in a condition of being normalized with respect to the color gamut of the apparatus. Therefore, when the area including the conversion pixel is detected, the normalized chroma of the representative color after the conversion with respect to the area is obtained (step S306).

The image data of the conversion pixel is then converted into coordinate values in the Luv color space (step S308). Here, the image data is RGB image data that can be directly converted into coordinate values in the Luv color space using a known conversion formula. After converting the Luv coordinate values of the conversion pixel along the normalized chroma (step S310), the Luv coordinate values thus converted are converted again into RGB image data (step S312). According to this process, it is possible to convert the image data of the conversion pixel into the image data on which the color mapping process is executed in accordance with the color gamut of the image output apparatus.

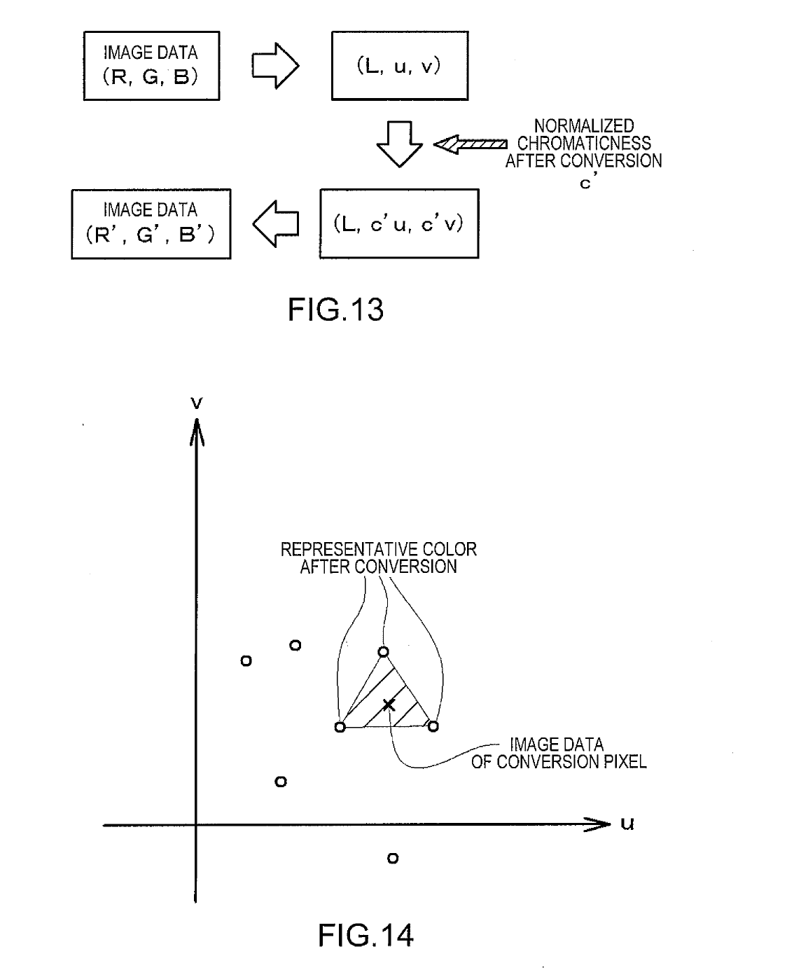

FIG. 13 is an explanatory diagram showing the process of converting the image data of the conversion pixel based on the normalized chroma of the converted representative color. As shown in FIG. 13, the RGB image data of the conversion pixel is converted into Luv coordinate values. Since the u-component and the v-component out of the coordinate values are related to the chroma, the conversion of the Luv coordinate values is performed by multiplying these components by the normalized chroma c′. Subsequently, by converting the Luv coordinate values thus obtained back to RGB image data, the converted image data can be obtained.

After thus obtaining the converted image data with respect to the conversion pixel, it is determined whether or not the image data has been converted with respect to all of the pixels included in the image (step S314). When pixels remain whose image data has not been converted yet (NO in step S314), the process returns to step S302 to select a new conversion pixel, and the subsequent series of processes described above are executed on the newly selected conversion pixel. When the image data is converted with respect to all of the pixels (YES in step S314), the image data conversion process of FIG. 12 is terminated, and the process returns to the color mapping process of FIG. 2.

In the color mapping process explained above, when converting the chroma expressed by the color image data in accordance with the color gamut of the image output apparatus, the pixels are collected into a plurality of pixel aggregates to extract the representative colors, thereby converting the color image data while the chroma difference between the representative colors is not varied as much as possible. Therefore, a preferable color image can be output while widely using the color gamut of the image output apparatus. In other words, since the conversion is executed so that the chroma difference between the representative colors is maintained as much as possible, excessive expansion or compression of the chroma of a certain hue compared to the chroma of another hue can be avoided. Further, it can also be avoided that the chroma is reversed between the hues, and that the chroma is expanded so that the area of the high chroma is similarly used in all of the hues to cause a dull image, thereby making it possible to output a preferable color image.

Since the pixels are collected into a plurality of pixel aggregates to convert the representative color of each of the pixel aggregates in accordance with the color gamut of the image output apparatus, the number of representative colors can be suppressed to a relatively small value. Therefore, even if the representative color is converted taking the chroma difference between the representative colors when converting the representative colors in accordance with the color gamut of the image output apparatus, the representative colors can quickly be converted in accordance with the color gamut of the apparatus. Therefore, a preferable color image can be quickly output while absorbing the difference between the color gamut of the image expressed by the color image data and the color gamut of the image output apparatus.

### C. MODIFIED EXAMPLES

Several modified examples of the color mapping process described above are now explained.

### C-1. First Modified Example

In the embodiment described above, it is assumed that when converting the color image data of the conversion pixel, the pixel aggregate including the conversion pixel is detected, and the color image data is converted using the normalized chroma c′ of the converted representative color stored with respect to the pixel aggregate. The method is simple, and therefore capable of quickly converting the color image data. However, from the viewpoint of improving the image quality, it is possible to convert the color image data using the chroma C′ obtained in a manner as described below instead of directly using the chroma c′ after conversion obtained with respect to the pixel aggregate including the conversion pixel.

FIG. 14 is an explanatory diagram showing the process of calculating the chroma c′ for converting the color image data of the conversion pixel in a first modified example. In FIG. 14, white circles represent the distribution of the representative colors after the conversion, and an “x” mark indicates the color image data of the conversion pixel. The values normalized in accordance with the image output apparatus, or the values before the normalization, can be used as the representative color and the color image data of the conversion pixel.

When converting the color image data of the conversion pixel, by detecting the representative colors in the periphery of the coordinate point of the conversion pixel indicated with the “x” mark in FIG. 14, and interpolating from the chroma c′ after the conversion obtained with reference to these representative colors, the normalized chroma c′ at the coordinate values of the conversion pixel is calculated. The color image data of the conversion pixel can be converted in the manner described above using the chroma c′ after the normalization thus obtained

According to this process, since the color image data is converted by appropriately expanding or compressing the chroma of the conversion pixel in accordance with the change in the chroma of the representative color, a preferable color image is output.

### C-2. Second Modified Example

In the embodiment described above, as shown in FIG. 4, the image is divided into a plurality of areas and the pixels included in each of the areas are collected as the pixel aggregate. However, the pixel aggregate is not limited to this form. For example, the pixels included in the image can be classified based on the color expressed by the image data of the pixel to form the pixel aggregate for every cluster of colors.

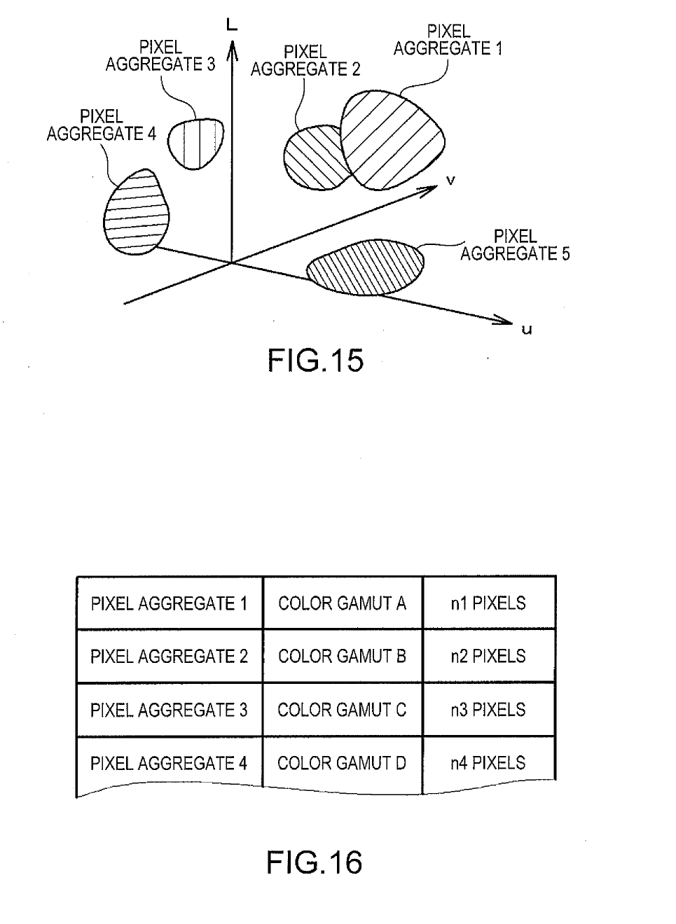

FIG. 15 is an explanatory diagram showing a process of generating the pixel aggregate with a cluster of colors expressed by the image data of the pixels in the second modified example. For example, when converting the color image data into the coordinate values of the Luv color space with respect to all of the pixels in the image, similar colors are converted into coordinate points adjacent to each other, and therefore, the pixels included in the image can be classified into several groups (i.e., pixel aggregates) as the clusters of colors. In FIG. 15, a condition of classifying the pixels into five groups, namely, pixel aggregates 1-5, is illustrated.

Further, the corresponding pixel aggregate can be previously stored for every pixel, and when determining the representative color of the pixel aggregate, the pixel of the directed pixel aggregate is extracted to determine the representative color with respect to the pixels.

Further, in addition to storing the pixel aggregate of each of the pixels, the color gamut can be previously obtained for every pixel aggregate shown in FIG. 15, and the data representing the color gamut can be added to the image data.

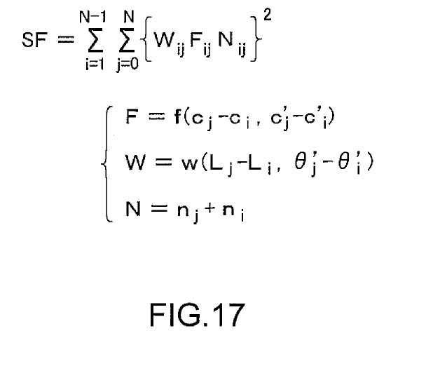

FIG. 16 is an explanatory diagram showing a condition of the data expressing the color gamut stored for each of the pixel aggregates. If the color gamut of each of the pixel aggregates is known as described above, the color at the center of the color gamut can be used as the representative color. Further, the number of pixels included in each of the pixel aggregates can be stored, and the evaluation function can be calculated taking the number of pixels included in the pixel aggregate into consideration. FIG. 17 shows a calculating formula for calculating the evaluation function in consideration of the number of pixels included in the pixel aggregate. The symbol nᵢ shown in FIG. 17 denotes the number of pixels included in the ith pixel aggregate. By thus taking the number of pixels into consideration, color image data can be converted so that the color used frequently is output as a preferable color taking the difference between the color used frequently in the image and the color used rarely therein into consideration.

Although embodiments of an image processing device according to the present invention are explained herein, the invention is not limited to these embodiments, and can be practiced in various forms while remaining within the scope and spirit of the invention.

What is claimed is:

1. An image processing device that performs, in response to receiving color image data, a process of converting the color image data in accordance with a color gamut that an image output apparatus can express, the image processing device comprising:
a representative color determining unit that determines, for each of a plurality of pixel aggregates formed by classifying pixels included in the color image data, a representative color representing the pixel aggregate;
an initial distribution setting unit that sets a distribution of representative colors in a predetermined color space as an initial distribution;
an evaluation function storage unit that stores a predetermined evaluation function that takes a value increasing as a chroma difference between one of the representative colors and another of the representative colors recedes from a chroma difference in a condition of the initial distribution;
an apparatus color gamut data obtaining unit that obtains apparatus color gamut data representing the color gamut that can be expressed by the image output apparatus;
a chroma changing unit that changes, after changing the chroma of a specific representative color out of the representative colors in accordance with the color gamut of the image output apparatus, the chroma of the remaining representative colors so that a summation of values of the evaluation function calculated between the representative colors becomes equal to or smaller than a predetermined value; and
an image data converting unit that converts the color image data with respect to each of the pixels in accordance with the representative colors changed by the chroma changing unit.

2. The image processing device according to claim 1, wherein
the representative color determining unit determines the representative color for each of areas formed by dividing the image expressed by the color image data taking the areas as the pixel aggregates.

3. The image processing device according to claim 1, wherein
the representative color determining unit determines the representative color for each of the pixel aggregates based on a positional relationship in a color space in a case of converting the color image data into a coordinate value of the color space.

4. The image processing device according to claim 1, wherein
the evaluation function storage unit stores the evaluation function that performs the evaluation so that the more significantly the hue is different between the representative colors, the lighter weight the evaluation is performed with.

5. The image processing device according to claim 1, wherein
the evaluation function storage unit stores the evaluation function that performs the evaluation so that the more significantly the brightness is different between the representative colors, the lighter weight the evaluation is performed with.

6. The image processing device according to claim 1, wherein
the evaluation function storage unit stores the evaluation function that performs the evaluation so that the larger the number of pixels included in the pixel aggregate is, the heavier weight the representative color is evaluated with.

7. The image processing device according to claim 1, further comprising:
a color gamut data reading unit that reads out color gamut data representing a range of colors expressed by the pixels in the pixel aggregate from the color image data,
wherein the representative color determining unit determines the representative color for each of the pixel aggregates based on the color gamut data read out for each of the pixel aggregates.

8. An image processing method that performs, in response to receiving color image data, a process of converting the color image data in accordance with a color gamut that an image output apparatus can express, the image processing method comprising:
determining, for each of a plurality of pixel aggregates formed by classifying pixels included in the color image data, a representative color representing the pixel aggregate;
setting a distribution of the representative colors in a predetermined color space as an initial distribution;
storing a predetermined evaluation function that takes a value increasing as a chroma difference between one of the representative colors and another of the representative colors recedes from the chroma difference in a condition of the initial distribution;
obtaining apparatus color gamut data representing the color gamut that can be expressed by the image output apparatus;
changing, after changing the chroma of a specific representative color out of the representative colors in accordance with the color gamut of the image output apparatus, the chroma of the remaining representative colors so that a summation of values of the evaluation function calculated between the representative colors becomes equal to or smaller than a predetermined value; and
converting the color image data with respect to each of the pixels in accordance with the representative colors changed.

9. A program embodied on a computer-readable medium that makes a computer realize a process of converting, in response to receiving color image data, the color image data in accordance with a color gamut that an image output apparatus can express, the process comprising:
determining, for each of a plurality of pixel aggregates formed by classifying pixels included in the color image data, a representative color representing the pixel aggregate;
setting a distribution of the representative colors in a predetermined color space as an initial distribution;
storing a predetermined evaluation function that takes a value increasing as a chroma difference between one of the representative colors and another of the representative colors recedes from the chroma difference in a condition of the initial distribution;
obtaining apparatus color gamut data representing the color gamut that can be expressed by the image output apparatus;
changing, after changing the chroma of a specific representative color out of the representative colors in accordance with the color gamut of the image output apparatus, the chroma of the remaining representative colors so that a summation of values of the evaluation function calculated between the representative colors becomes equal to or smaller than a predetermined value; and
converting the color image data with respect to each of the pixels in accordance with the representative colors changed.
